(19) United States
(12) Patent Application Publication
(10) Pub. No.: US 2024/0430001 A1
(43) Pub. Date: Dec. 26, 2024

(54) SYSTEM AND METHOD FOR SINGLE FREQUENCY NETWORK TRANSMISSION AND SIGNAL STRENGTH MAPPING

(71) Applicant: Christopher F. DEVINE

(72) Inventor: Christopher F. DEVINE

(21) Appl. No.: 18/213,752

(22) Filed: Jun. 23, 2023

(51) Int. Cl. H04B 7/26; H04B 7/08

(52) U.S. Cl. CPC H04B 7/2606; H04B 7/0854

(57) ABSTRACT

Signal broadcasting related equipment is provided that enables design, deployment, demonstration and/or documentation of targeted transmitted broadcast delivery in a broadcast area wherein a plurality of transmitters are used to transmit broadcasting area wide programming and localized auxiliary information on a single frequency and wherein the plurality of transmitters includes at least on main transmitter for transmitting broadcast area wide programming and, optionally, a plurality of booster transmitters for transmitting localized, targeted auxiliary information so as to provide customized, targeted content for delivery to particular locations and areas.

### CROSS REFERENCE AND PRIORITY CLAMS

This patent application claims priority to U.S. Provisional Application No. 63/355,388 filed Jun. 24, 2022, and entitled “Main Transmitter and Single Frequency Network Signal Strength Mapping, U.S. Non-provisional application Ser. No. 17/855,096 filed Jun. 30, 2022, and entitled “Zone Casting Linked to Smart Devices and Push Notification Functionality,” and U.S. Non-provisional application Ser. No. 17/855,004 filed Jun. 30, 2022, and entitled “Reduction of Overlap During Zone Casted Transmission with Alternate Main Transmitter and Time Alignment for Overlayed Radio Transmissions,” the disclosures of which being incorporated herein by reference in their entireties.

### FIELD

Disclosed embodiments are directed, generally, to equipment for the design, deployment, demonstration and documentation of the effectiveness of broadcasting equipment including, for example, use of a plurality of booster/auxiliary transmitters to augment a main transmitter(s) for a broadcast area.

### BACKGROUND

As disclosed in incorporated U.S. Pat. No. 8,862,048, broadcasters' listening areas associated with a metropolitan area or geographic region. The technology disclosed in U.S. Pat. No. 8,862,048 and the other patent applications incorporated herein pertain to two types of technology which may be used by broadcasters to improve their broadcast functionality: ZoneCasting™ and MaxxCasting™.

This application incorporates by reference in their entirety, the following United States Patent Applications and granted United States Patents: U.S. patent application Ser. No. 13/626,969, filed Sep. 26, 2012, published as US Pat. Pub. 20130094426-A1, and entitled “Equipment, System And Methodologies For Transmitting Localized Auxiliary Information And RDS/RBDS Information Via Multiple RF Frequencies, RF Power, And Antenna Selection Of Boosters In A Segmented Listening Area Delivering Localized Auxiliary Information,” U.S. patent application Ser. No. 13/245,482, filed Sep. 16, 2011, published as US Pat. Pub. US 20120014370-A1, and entitled “Equipment, System and Methodologies for Time Synchronization Between Multiple RF Frequencies, RF Power, and Antenna Selection of Boosters In a Segmented Listening Area,” U.S. patent application Ser. No. 13/706,812, filed Dec. 6, 2012, published as US Pat. Pub. US 20130102241-A1, and entitled “Targeted Content Insertion for Devices Receiving Radio Content,” and U.S. Pat. No. 8,862,048, filed Sep. 10, 2010, and entitled “Equipment, System and Methodologies For Segmentation Of Listening Area Into Sub-Areas Enabling Delivery Of Localized Auxiliary Information.”

### SUMMARY

The following presents a simplified summary in order to provide a basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to the more detailed description below.

Disclosed embodiments provide signal broadcasting related equipment that enables design, deployment, demonstration and/or documentation of targeted transmitted broadcast delivery in a broadcast area wherein a plurality of transmitters are used to transmit broadcasting area wide programming and localized auxiliary information on a single frequency and wherein the plurality of transmitters includes at least one main transmitter for transmitting broadcast area wide programming and, optionally, a plurality of booster transmitters for transmitting localized, targeted auxiliary information so as to provide customized, targeted content for delivery to particular locations and areas.

### BRIEF DESCRIPTION OF FIGURES

The patent or application file contains at least one drawing executed in color. Copies of this patent or patent application publication with color drawing(s) will be provided by the Office upon request and payment of the necessary fee.

A more complete understanding of the present invention and the utility thereof may be acquired by referring to the following description in consideration of the accompanying drawings, in which like reference numbers indicate like features, and wherein:

FIG. 1 illustrates an example of equipment utilized to provide mobile field unit functionality to gather signal strength data associated with the transmission signals for one or more transmission sources in a particular coverage area in accordance with disclosed embodiments.

FIG. 2 illustrates an example of operations for formulating a station service coverage map in accordance with the disclosed embodiments in accordance with disclosed embodiments.

FIG. 3 illustrates the operational workflow coordinated by the disclosed system and methodologies enabling a user to input data to facilitate analysis of a particular radio station's coverage area/reach profile in accordance with disclosed embodiments.

FIG. 4 illustrates an example of a mapping representation showing a high level representation of a geographic area along with a field/drop-down menu icon that enables input of data indicating a particular broadcast market in accordance with disclosed embodiments.

FIG. 5 illustrates an example of a mapping representation showing a mid-level representation of a geographic area along with a field/drop-down menu icon that enables input of data indicating a particular station within the broadcast market in accordance with disclosed embodiments.

FIG. 6 illustrates an example of a signal strength indication map providing differentiated display of geographic areas based on field data indicating relative signal quality facilitating content and service delivery in accordance with disclosed embodiments.

FIG. 7 illustrates an example of a field/drop-down menu icon that includes illustration of the commercial businesses within the specified category enables selection of a location overlay by selection of category in accordance with disclosed embodiments.

FIG. 8 illustrates another example of a map illustrating differentiated display of geographic areas receiving an unacceptably bad signal quality facilitating content and service delivery and geographic areas receiving an acceptable signal quality to facilitate content and service delivery in accordance with disclosed embodiments.

FIG. 9 illustrates an additional example of a field/drop-down menu icon that enables input and reception of a business name in accordance with disclosed embodiments.

FIG. 10 illustrates an example a signal strength map generated based on receipt of input of a business name in accordance with FIG. 9 in accordance with disclosed embodiments.

FIG. 11 illustrates various examples of different overlays have corresponding additional information for display in accordance with disclosed embodiments.

FIG. 12 illustrates an example of measured data levels associated with a field measured sample as well as a sample for a user/listener to review the sampled audio for that measurement in accordance with disclosed embodiments.

FIG. 13 illustrates a signal map indicating both differentiated signal data and data indicating locations of entities within the coverage area related to selected categories/businesses in accordance with disclosed embodiments.

FIG. 14 illustrates an example of the user/system interaction associated with providing side-by-side comparison functionality in accordance with the disclosed embodiments for comparison of a station's coverage/reach profile with another station in accordance with disclosed embodiments.

FIG. 15 illustrates an example of how disclosed embodiments may be configured to display a field/drop-down menu icon that enables input and reception of another station in the market area that may be compared with the selected station in accordance with disclosed embodiments.

FIG. 16 illustrates an example of how side-by-side comparison of coverage area and quality may be illustrated to enable comparison of demonstrable data indicating the actual received signals in a particular geographic area in accordance with disclosed embodiments.

FIG. 17 illustrates an example of the relative relationship data indicating the proximity between a business and a station and station's coverage area that may be illustrated in the comparison view in accordance with disclosed embodiments.

FIG. 18 illustrates various overlays of data that may be added from a standard or customized list of available overlays of available data, in particular demographic data indicating the ethnicity of population in the coverage area in accordance with disclosed embodiments.

FIG. 19 illustrates an example of the user/system interaction associated with analyzing, demonstrating and documenting comparison of the effect of utilizing technology to improve the effectiveness of transmission signals in a broadcast area in accordance with disclosed embodiments.

FIG. 20 illustrates the field/drop-down menu icon that enables input and reception of a user's selection of analysis functionality associated with side-by-side-comparison of demonstrated effect of implementation of a coverage optimization technology in accordance with disclosed embodiments.

FIG. 21 illustrates graphical documentation of the forecasted effect of implementation of a coverage optimization technology, e.g., MaxxCasting™ v. Without MaxxCasting™ in accordance with disclosed embodiments.

FIG. 22 illustrates graphical documentation of the forecasted effect of implementation of a coverage optimization technology, e.g., MaxxCasting™ v. Without MaxxCasting™ with overlaid POI in accordance with disclosed embodiments.

FIG. 23 illustrates an example of the broadcast area constituent component broadcast equipment that may be optimized by the design, deployment, demonstration and documentation functionality in accordance with disclosed embodiments.

### DETAILED DESCRIPTION

As explained briefly above, ZoneCasting™ technology enables local broadcast stations (e.g., radio broadcasters, but not limited to radio) to broadcast their advertisements, programming, news, emergency alerts and other content to either their full coverage area or for a limited part of each hour to smaller geo-targeted zones in its coverage area (also referred to colloquially as their “market.” For example, a New York City radio station, which typically reaches the tri-state area along with all of Long Island, could provide critical weather updates solely to parts of New Jersey. As a result of ZoneCasting™ technology, broadcast audiences benefit from more geographically relevant content. Additionally, if communities of specific language or dialect speakers are located in a specific focused geographic regions, ZoneCasting™ can provide the ability to provide customized content via broadcast.

However, accurate design of broadcast equipment (e.g., placement of transmitters and analysis and configuration of transmitter parameters) for ZoneCasting™ is key to effective deployment, demonstration and documentation of specialized content to meet the interests of localized communities, e.g., more relevant with programming, news, weather, emergency alerts and advertisements.

Likewise, MaxxCasting™ technology enables the ability to remediate inadequate transmission signal strength to counter geographic and physical barriers to signal transmission in a broadcast area. More specifically, MaxxCasting™ expands the coverage area of a transmission signal, e.g., FM radio signal, to enable potential geographic targeting and fencing of content including text advertising and messaging. MaxxCasting™ uses Single Frequency Networks (SFN) with transmitters fully synchronized to boost the signal from the main transmitter with seamless transitions from the main to and between the booster nodes. MaxxCasting uses modern cellular network design, broadcast, and SFN software tools utilizing high resolution terrain data including building heights, propagation tuning based upon real-time field measurements, as well as analysis of vehicular traffic, and demographics.

Disclosed embodiments provide signal broadcasting related equipment that enables design, deployment, demonstration and/or documentation of targeted transmitted broadcast delivery in a broadcast area wherein a plurality of transmitters are used to transmit broadcasting area wide programming and localized auxiliary information on a single frequency and wherein the plurality of transmitters includes at least on main transmitter for transmitting broadcast area wide programming and, optionally, a plurality of booster transmitters for transmitting localized, targeted auxiliary information so as to provide customized, targeted content for delivery to particular locations and areas.

Disclosed embodiments provide a system and methodologies for creating and utilizing highly accurate maps of predicted radio frequency signal strength levels produced by the coordinated operation of at least one main transmitter and one or more booster transmitters. The system and methodologies acquire, store, process and output the resulting mapping data to various software program interfaces to enable design, deployment, demonstration and documentation.

In accordance with at least one disclosed embodiment, a system and method are provided that acquire, store, and analyze data in a database or data store so as to provide three-dimensional (hereafter “3D”) geospatial maps that include latitude, longitude and altitude data indicating predicted terrestrial radio, terrestrial television and/or satellite broadcast signal strength level estimation data for a broadcasting system.

As explained above, the broadcasting systems to be analyzed may include one or more main transmitters and, optionally, one or more same frequency booster transmitters (also referred to herein as “Single Frequency Network or SFN nodes”). In accordance with the disclosed embodiments, 3D spatial map(s) may represent signal strength within a broadcasting system's coverage area in three-dimensional space, for reception by fixed and mobile receivers (which may be either receivers or transceivers including both receiving and transmitting capability).

Accordingly, disclosed embodiments use various system components to provide such functionality including field instrumentation comprised of mobile units configured to collect field data for diagnostic analysis and documentation purposes. Such mobile units are transported to various locations within a broadcast area, all the while measuring received signals to determine signal strength and sampling received data for the purposes of demonstrating received signal quality. Such field data may then be combined with additional regulatory, commercial and publicly available data for analysis by a server, implemented, diagnostic module to formulate mapping data.

For the purposes of explanation only, the functionality, operation and utility of the disclosed embodiments within the context of FM radio. However, it should be understood that the disclosed embodiments provide utility for terrestrial radio, terrestrial television or satellite broadcast signals as well as datacasting and the like.

In accordance with disclosed embodiments, mobile field units 100 may be configured to measure and record FM station signals throughout a broadcast area. Thus, the mobile field units 100 may use specialized equipment to collect and analyze such HD Radio (HDR) and Frequency Modulated (FM) signals, for example, a Nomad HDR/FM Analyzer™, which is manufactured by and commercially available from Octave Communications of Granby, Quebec, Canada. Although various different types of network analyzers may suffice to provide functionality for the mobile field units 100, in at least one implementation, the network analyzer may be equipped with a Signal Hound™ spectrum analyzer (manufactured by and commercially available from Signal Hound of Battle Ground, Washington) and Inovonics™ receivers (specifically, for example, models 565/568/635/638 manufactured by and commercially available from Inovonics Wireless Corporation of Broomfield, Colorado) and designed for smart HD Radio™ and Analog FM mobile measurement of a plurality (e.g., up to five) channels.

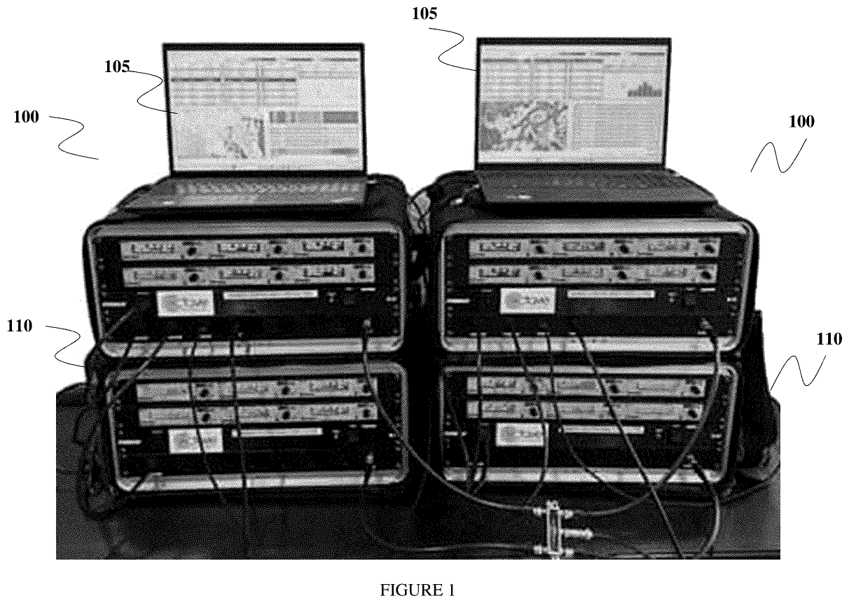

FIG. 1 illustrates an example of equipment utilized to provide mobile field unit functionality to gather signal strength data associated with the transmission signals for one or more transmission sources in a particular coverage area. In at least one implementation, the mobile field unit 100 may utilize a highly accurate GPS monitoring system using, for example, Wide Area Augmentation System (WAAS)/European Geostationary Navigation Overlay Service (EGNOS) satellites to provide a time-based or distance-based data acquisition associated with corresponding geotags.

Implementation using the Nomad HDR/FM Analyzer™ has additional utility beyond what is commercially available because, for the disclosed embodiments, the equipment has been upgraded by customization to perform full market monitoring. In particular, each mobile field unit 100 is capable of recording data for twelve transmitting sources (e.g., radio stations) simultaneously.

As illustrated in FIG. 1, two mobile field units 100 may be used simultaneously to measure and record twenty-four channels per field mapping run. Each field unit includes the analyzer equipment package 110 described above as well as computer processing equipment running on a computer device 105 (e.g., laptop) to coordinate the functionality of the analyzer to measure transmitted signals discussed herein.

In particular, in operation, the spectrum analyzer measures the Radio Frequency (RF) level of HD Radio sideband ratios to analog and interferer carriers along with analog FM RF level of each station for the entire FM band. Inovonics™ receivers may be configured and controlled to capture various metrics for HD Radio™, FM, Radio Data System (RDS) and Radio Broadcast Data System (RBDS). A subset of selected metrics, for example, HD Digital Audio Acquired, Main channel power levels, Multipath, and adjacent channel power levels will be uploaded to the server-implemented coverage analytics module and made available for users in the sales mode and/or engineering mode (details discussed herein).

In accordance with various disclosed embodiments the field data and/or the subset of selected metrics may be stored in one or more databases or data stores included on or accessible by one or both of the mobile field units (in particular the computer processing devices implementing the functionality of the mobile field units) and the server implemented coverage analytics module. Thus, one or more databases or data store may be generated and associated processes provided to output predicted contour maps with predicted signal levels for terrestrial commercial and non-commercial FM broadcast radio stations, terrestrial commercial and non-commercial broadcast television stations, direct broadcast satellite systems and the like. It should be understood that databases of the gathered and analyzed data may be used to store the data in an organized and accessible manner for use by various software applications and end users using the same to design, deploy, demonstrate and/or document the signal strength within a broadcast area. However, it should be appreciated that various other data storage configurations that may not be strictly considered database oriented, for example, data feeds, to process received data in real time or near real time, may be utilized as would be understood by one of ordinary skill in the art.

Broadcast area coverage maps for particular radio stations may be generated using, for example, the HTZ Communications package, which is an RF signal prediction software commercially available from ATDI Communications of Paris, France. Though initially configured for cellular communications, the HTZ Communications package now covers other technologies including broadcast, satellite/earth station, microwave links and point-to-multipoint transmission, aeronautical and transmission for Unmanned Aeronautical Vehicles (UAVs). HTZ Communications package provides advanced radio network planning and optimization capabilities for most technologies operating from a few kHz to 1 THz and supports a library of over fifty empirical, deterministic and hybrid propagation models, including all ITU-R models, Okumura-Hata, Cost-Hata, and Irregular Terrain Model-Longley Rice. ATDI offers high-resolution terrain elevation, building data and clutter maps using data from USGS LIDAR down to 10 meter resolution for broadcast technology.

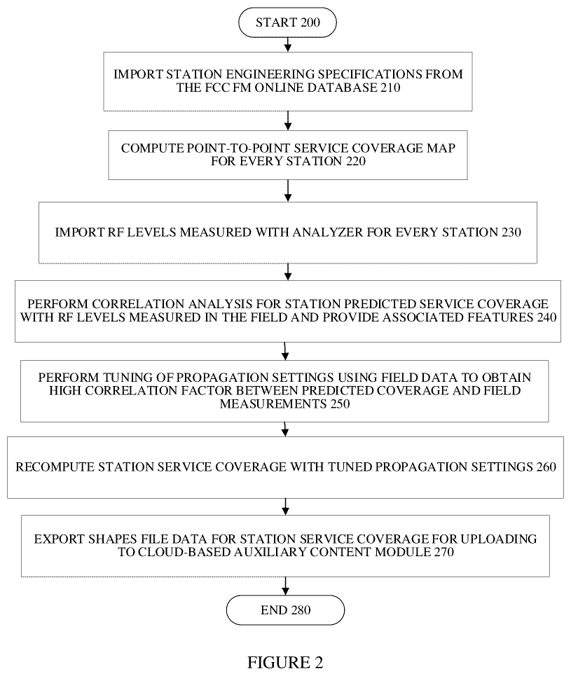

FIG. 2 illustrates an example of operations for formulating a station service coverage map in accordance with the disclosed embodiments. As shown in FIG. 2, operations begin at 200 and control proceeds to 210 at which the operations begin for computing every station service coverage map. More specifically, at 210, station engineering specifications are imported from the US Federal Communications Commission (FCC) FM online database into the HTZ communications package. It should be understood that importation from other data sources may be performed as appropriate depending on the location of the station(s) to be mapped. Additionally, it should be understood that the data may be captured manually and imported in this manner if a regulatory agency does not provide the relevant data.

Once relevant engineering specification data has been imported, a point-to-point service coverage map is computed for every station to be included in the field run using the HTZ Communications package at 220.

Thereafter, control proceeds to 230, at which RF levels measured with the mobile field units are imported for every station into the HTZ Communications package. Control then proceeds to 240, at which a correlation analysis is performed for every station's predicted service coverage using the RF levels measured in the field. Functionality for performing the correlation analysis may be provided by the HTZ Communications package.

Control then proceeds to 250, at which fine tuning of the propagation settings is performed using the field data to obtain a high correlation factor between the predicted coverage and the field measurements (i.e., correlation factor should be >0.92) for the service coverage for every station included in the field run. Functionality for performing the fine tuning to achieve the correlation factor may be provided by the HTZ Communications package.

Thereafter, at 260, the station service coverage is recomputed with the tuned propagation settings. Next, control proceeds to 270, at which shapes files data for every station service coverage to be uploaded to server implemented coverage analytics module are exported. Control then proceeds to 280, at which this phase of the operations ends.

As part of the analysis of the mobile field unit generated data, in accordance with disclosed embodiments, various thresholds for received signal quality are defined to appropriately convey the effect of the field measurements captured by the mobile field units. In particular, a consistent schedule of characterizations of field strength and associated real world effect is provided. For example, in the context of radio broadcasting, such a schedule may be formulated as follows: x<34 dBu: degraded audio; x≥34 dBu: listenable audio; x≥47 dBu: stereo mobile coverage; and x≥54 dBu: Indoor coverage (note, these demarcations are merely examples of potential categorization shifts).

In accordance with at least some disclosed embodiments, the system utilizes data utilities, applications, and user interface(s) to depict visualizations of signal coverage areas, for example, with an interactive predicted contour map with predicted transmission signal levels. Thus, based on the file data exported to the server implemented coverage analytics module and the schedule of characterization schedule, a variety of coverage maps provide different information for use in design, deployment, demonstration and documentation of a station's coverage area.

For example, as mentioned above, the disclosed embodiments may be used to provide systems and functionality that operate in one or more modes, for example, sales mode, and/or, engineering mode. Sales mode may be used to analyze and generate field data and mapping useful in demonstrating and documenting the coverage map provided by a particular station relative to particular commercial locations, demographic areas of consumers and the like, as disclosed herein in detail. The engineering mode may be used to analyze and generate field data and mapping useful in the design and deployment of transmission equipment to increase signal strength, further improve coverage area or address issues of geographic or physical obstacles to signal coverage in a broadcast area (e.g., for use in conjunction with the analysis for the need or use of MaxxCasting™ technology), as disclosed herein in detail.

For the sales mode, generated coverage maps may, for example, have any variety of colors signifying different characterizations of locations within the mapped coverage area. These color designations and the signal strengths they signify may be configurable by a user or be pre-set to a system default. For example, coverage maps in the sales mode may include two colors: red signifying a bad signal strength (e.g., x<34 dBu) and green signifying a good signal strength(x≥34 dBu). Of particular note, this exemplary threshold may, for example, correlate with various metrics and audio quality captured by the Inovonics™ receivers of the Nomad HDR/FM Analyzer™.

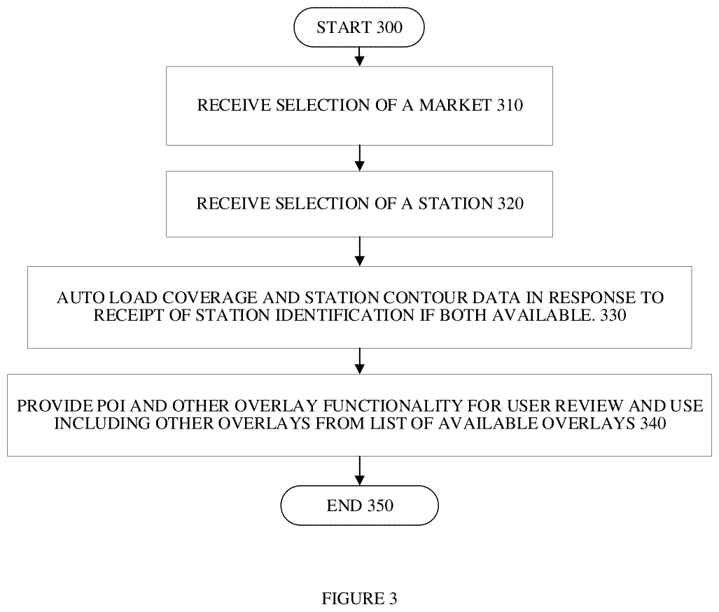

FIGS. 3-22 illustrate the operational functionality and software implemented tools for performing design, deployment, demonstration and documentation of a broadcast area in accordance with the disclosed embodiments.

FIG. 3 illustrates the operational workflow coordinated by the disclosed system and methodologies enabling a user to input data to facilitate analysis of a particular radio station's coverage area/reach profile. As shown in FIG. 3, the operations begin at 300 and control proceeds to 310, at which selection of a particular market/broadcast area/geographic location is received by the system. It should be understood that user input of data may be performed via one or more different types of computing devices including but not limited to laptop computer, personal computing device, mobile computing device, etc. It should also be appreciated that the input data may include but is not limited to postal code, city/municipality/state/county/district/country, longitude and latitude coordinates, or indication provided by selection, by a user, of a geographic area on a displayed geographic map. It should be understood that the capability to select a particular market may be output to a user via a software user interface immediately following the user's initial login to the system as a user of its functionality.

Once the selection of the market has occurred at 310, control proceeds to 320, at which the user can select and selection is received of a station within the market. Following receipt of the station identification and retrieval of station contour data for the identified station, the coverage and station contour data is automatically loaded into the server implemented coverage analytics module at 330. Thereafter, Point of Interest (POI) data and other overlay functionality is provided in an output graphical display via a user interface for user review and use at 340. In this particular implementation, the overlays may include one of a plurality of overlays from a list of available overlays provided to the user for selection. Subsequently, this phase of the system and methodologies operations ends at 350.

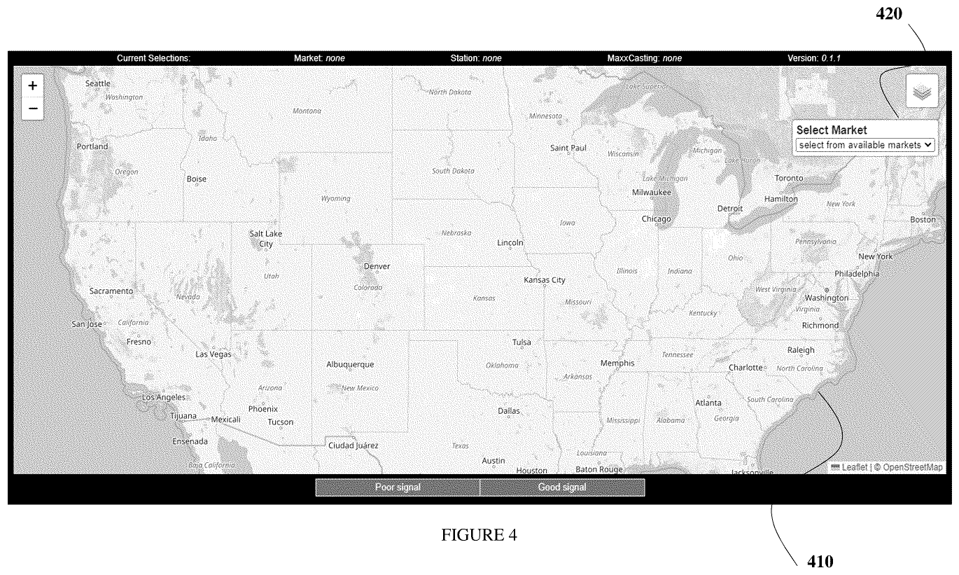

As indicated above, various feature mapping functionality results from the operations performed in FIG. 3. For example, as shown in FIG. 4, a mapping representation may be generated and output in the sales mode that shows a high level representation of a geographic area 410 along with a field/drop-down menu icon 420 that enables input of data indicating a particular broadcast market. Throughout the following disclosure, various details may differ between such output displays in sales mode and engineering mode, e.g., in engineering mode, the display may include a field format that enables selection of a market of interest based on more technical-based data. The engineering mode has more available overlay options and the granularity with which the data is displayed is finer.

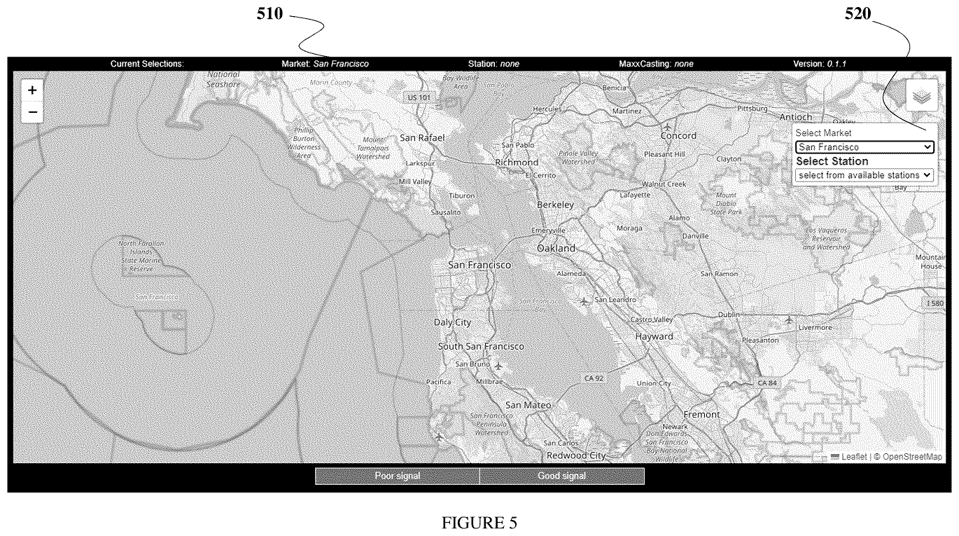

As shown in FIG. 5, a mapping representation may be generated and output in the sales mode that shows a mid-level representation of a geographic area 510 along with a field/drop-down menu icon 520 that enables input of data indicating a particular station within the broadcast market, output in the sales mode version. Like FIG. 4, the FIG. 5 illustration of the sales mode generated display may differ from that generated by the display generated in the engineering mode based simply on additional functionality enabling more technical-based specification of the station of interest.

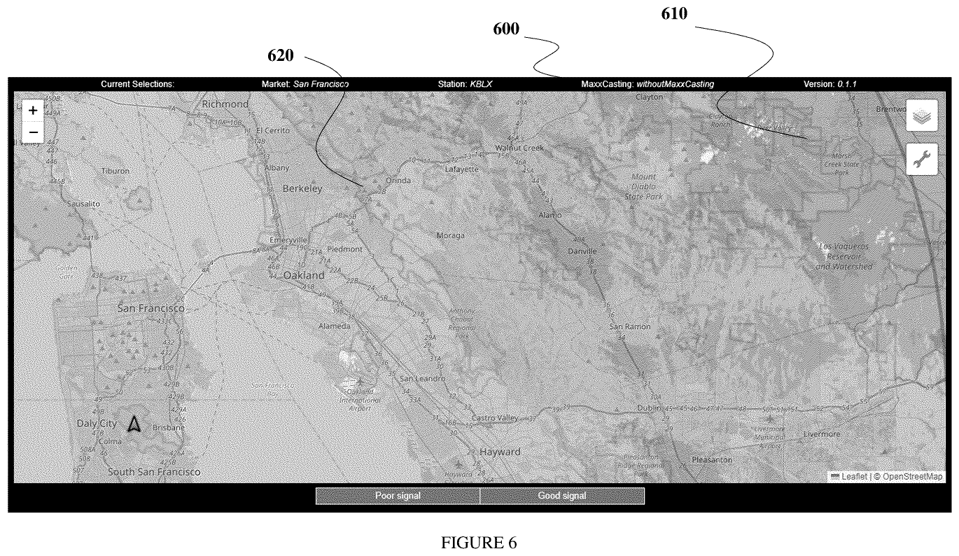

FIG. 6 illustrates an example of a sales mode generated signal strength indication map 600 wherein, as explained above, red regions 610 indicate those geographic areas receiving an unacceptably bad signal quality facilitating content and service delivery and green 620 regions indicate those geographic areas receiving an acceptable signal quality to facilitate content and service delivery.

The engineering mode has more available overlay options and the granularity with which the data is displayed is finer.

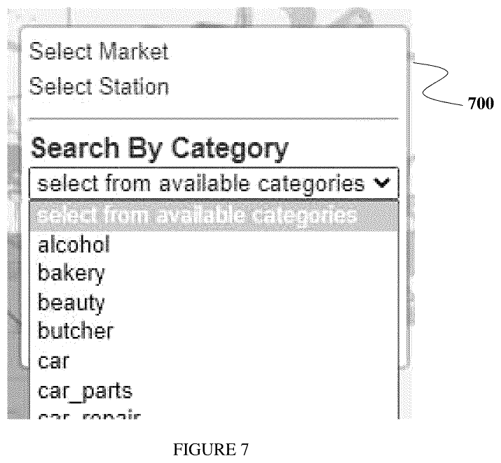

FIG. 7 illustrates an example of a field/drop-down menu icon 700, that includes illustration of the commercial businesses within the specified category enables selection of a location (POI) overlay by selection of category (e.g., alcohol, bakery, beauty, butcher, car, etc.).

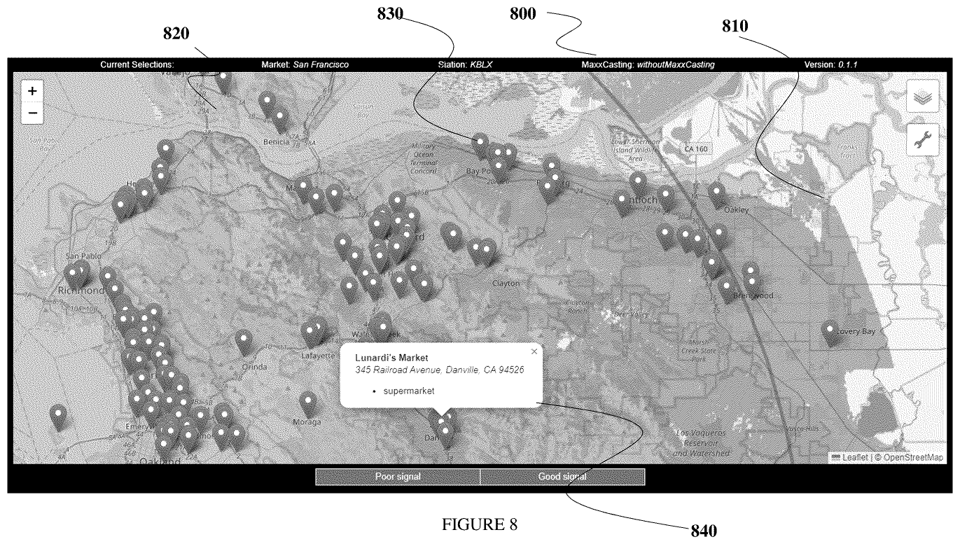

FIG. 8 illustrates an example of a map 800 wherein, as explained above, red regions 810 indicate those geographic areas receiving an unacceptably bad signal quality facilitating content and service delivery and green 820 regions indicate those geographic areas receiving an acceptable signal quality to facilitate content and service delivery. Additionally, map 800 includes an illustration of indication of the location 830 of the commercial businesses within the specified category as well as the ability to “hover” on a particular location to trigger display of information 840 about a particular business in the specified category at a particular geographic location.

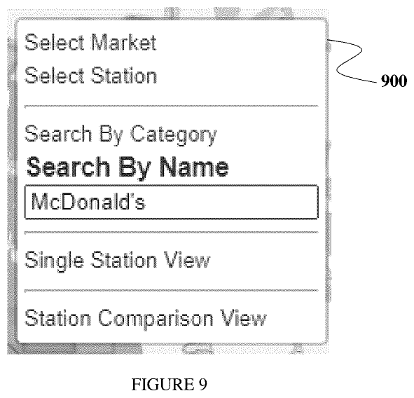

Optionally, an additional field/drop-down menu icon 900 may be provided that enables input and reception of a business name as shown in FIG. 9.

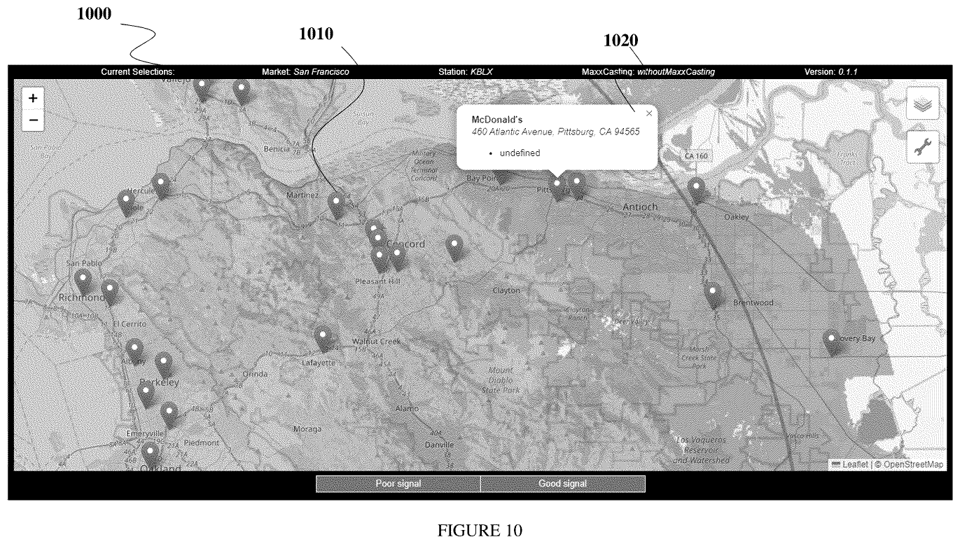

As a result, receipt of input of a business name is used to enable output and display a signal strength map 1000 (see FIG. 10) including the locations 1010 of the received business name as well as the ability to “hover” on a particular location to trigger display of information 1020 about a particular location of the specified business at the particular geographic location.

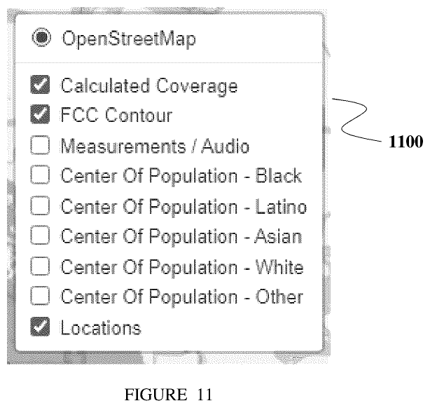

It should be appreciated that other overlays of data may be added from a standard or customized list of available overlays of available data. For example, FIG. 11 illustrates various examples 1100 of different overlays have corresponding additional information available on them.

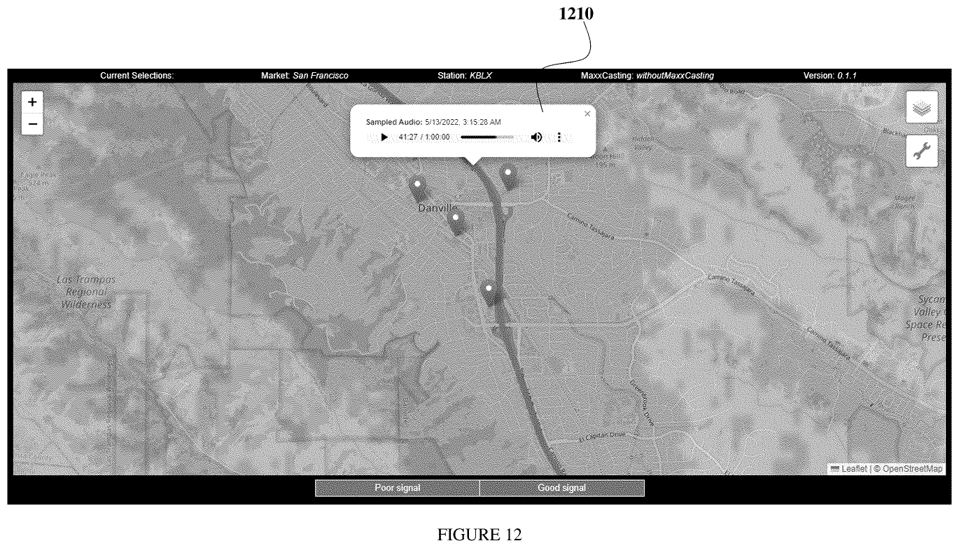

In accordance with the disclosed embodiments, clicking on a measurement on an RF measurement overlay may trigger output of data 1210 associated with the measurement, e.g., measured data levels associated with field measured sample as well as a sample for a user/listener to review the sampled audio for that measurement (see FIG. 12). Again, as disclosed throughout this application, such samples are not limited to audio samples and diagnostics are not limited to radio/audio. It should be understood that the illustration provided in FIG. 12 may be configured for generation in sales mode; however, an output display of utility data may be different if generated in engineering mode, e.g., there may be an increased level of granularity in coverage overlays and RF measurement field/drop-down menu icons.

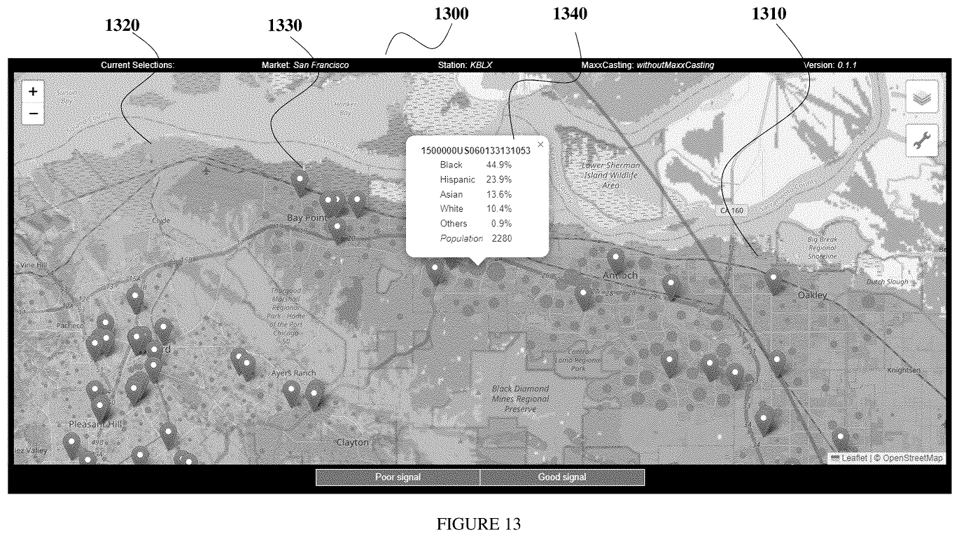

As further illustrated in FIG. 13, the system and methodologies may be configured to display a coverage map 1300 including both differentiated signal data (1310 indicating unacceptable signal quality; 1320 acceptable signal quality), data indicating locations of entities within the coverage area related to selected categories/businesses/otherwise (explained above) as well as an icon indicating population data indicating the a user actuating, i.e., “clicking on” a center of population icon illustrated in a population overlay, which will trigger display of census population breakdown data for the displayed measurement area. The engineering mode has more available overlay options and the granularity with which the data is displayed is finer.

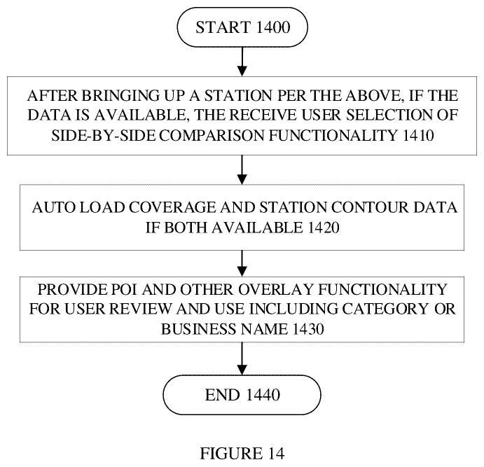

FIG. 14 illustrates an example of the user/system interaction associated with providing side-by-side comparison functionality in accordance with the disclosed embodiments for comparison of a station's coverage/reach profile with another station. As shown in FIG. 14, like FIG. 3, the methodology outputs station data, if the received user data is available, for side-by-side comparison functionality at 1410. Thereafter, the station contour data and coverage data are both loaded as a result of both being available at 1420. In this way, after bringing up a station per the above, the user can select a station to compare the reference station to. Coverage and station contour will auto load if they are both available. Thereafter, at 1430, POI overlay functionality may be provided based on category and/or business name (e.g., optional overlay may be output to a user via displayed graphic on both maps from a single query. It should be appreciated that other overlays of data may be added from a standard or customized list of available overlays of available data. The engineering mode has more available overlay options and the granularity with which the data is displayed is finer.

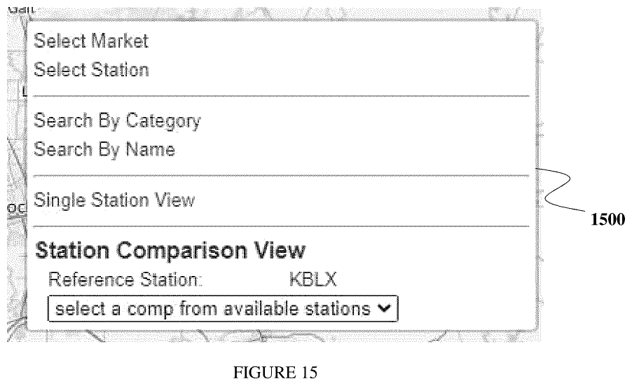

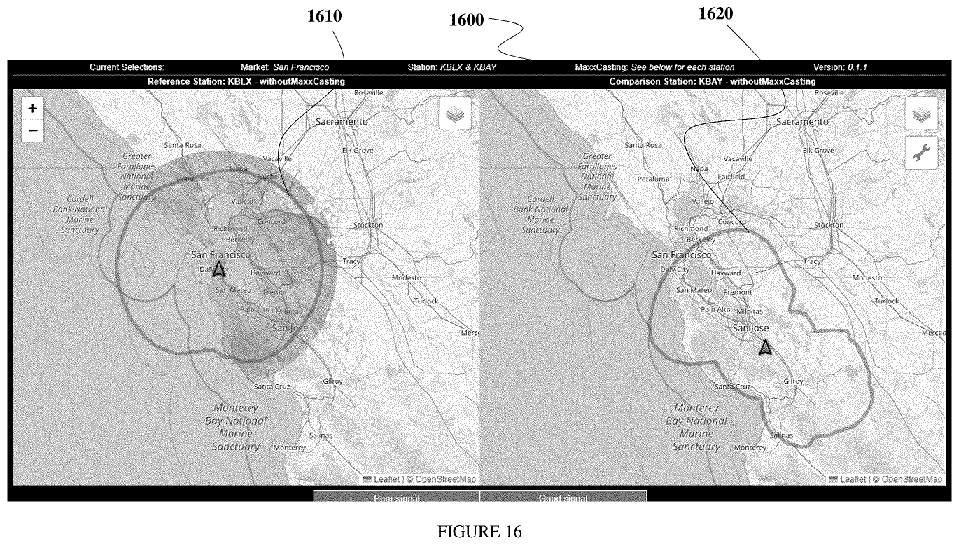

As illustrated in FIG. 15, once a particular station has been identified, the disclosed embodiments may be configured to display a field/drop-down menu icon 1500 that enables input and reception of another station in the market area that may be compared with the selected station. This side-by-side comparison 1600 of coverage area and quality may be illustrated to enable comparison of demonstrable data indicating the actual received signals in a particular geographic area as shown in FIG. 16. Thus, as shown in 1610, a particular broadcast area may illustrate the signal quality of a particular station, in comparison to the broadcast area 1620 provided by a comparison station to enable a user to determine which geographic footprint is the most effective use of their advertising budget given a particular geographic and demographic target audience. In this regard, it should be understood that POI overlays may be provided by category or business name, POI overlay functionality may be provided based on category and/or business name (e.g., optional overlay may be output to a user via displayed graphic on both maps from a single query. It should be appreciated that other overlays of data may be added from a standard or customized list of available overlays of available data.

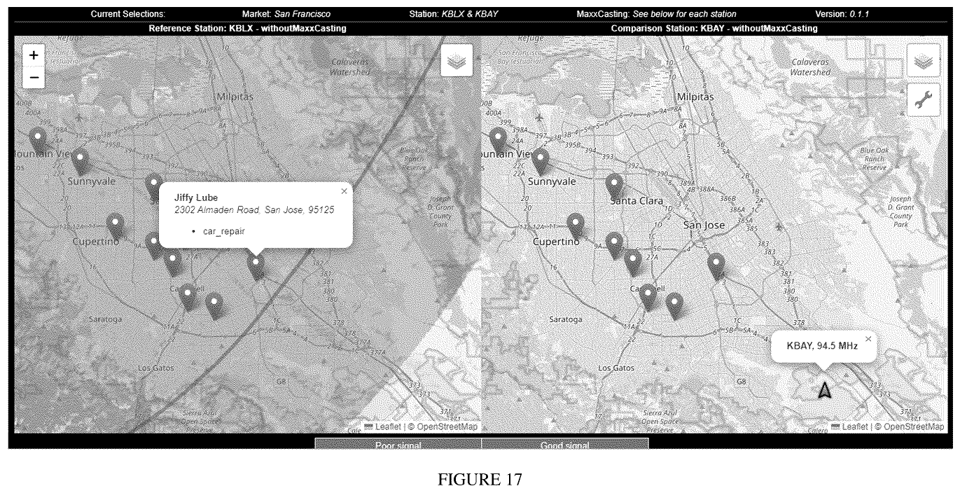

Further, as illustrated in FIG. 17 relative relationship data indicating the proximity between a business and a station and station's coverage area may be illustrated in the comparison view.

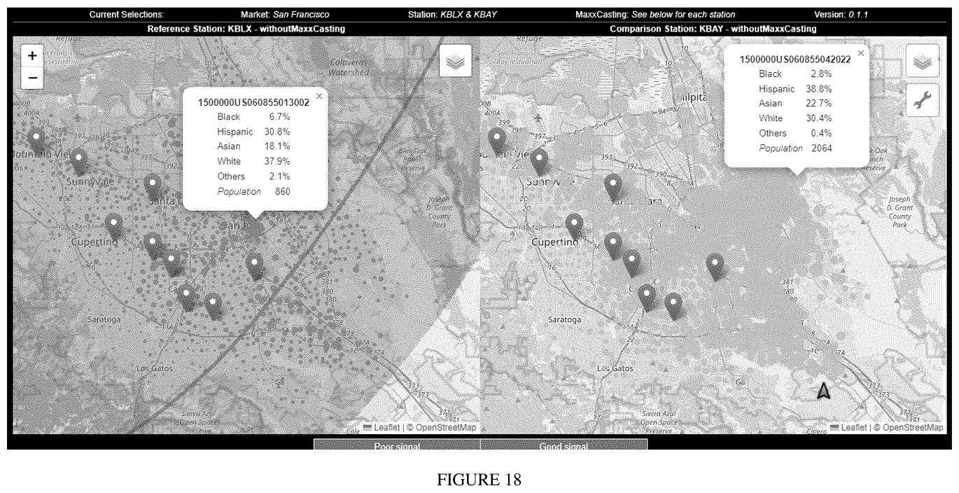

Still further, it should be appreciated that various other overlays of data may be added from a standard or customized list of available overlays of available data, in particular demographic data indicating the ethnicity of population in the coverage area (see FIG. 18) and relative to the specified business location, and socioeconomic data as well.

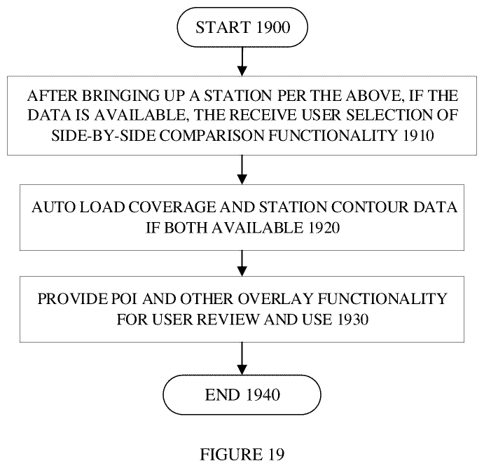

FIG. 19 illustrates an example of the user/system interaction associated with analyzing, demonstrating and documenting comparison of the effect of utilizing technology to improve the effectiveness of transmission signals in a broadcast area. In particular, for example, FIG. 19 illustrates side-by-side comparison functionality in accordance with the disclosed embodiments for comparison of a station's coverage/reach profile before and after implementing an optimization tool such as MaxxCasting™. As shown in FIG. 19, like FIGS. 3 and 14, the methodology outputs station data, if the received user data is available, for side-by-side comparison functionality at 1910. Thereafter, the station contour data and coverage data are both loaded as a result of both being available at 1920.

However, in this process functionality, the determined and displayed data indicates the technical effect of implementing additional technology to optimize the coverage of transmitted signals in a market area. In this way, after bringing up a station per the above, the user can select one or more optimization methodologies to determine the effect on coverage for the specified station. Thus, as in other functionality disclosed herein, coverage and station contour will auto load if they are both available. Thereafter, at 1930, POI overlay functionality may be provided based on category and/or business name (e.g., optional overlay may be output to a user via displayed graphic on both maps from a single query. It should be appreciated that other overlays of data may be added from a standard or customized list of available overlays of available data. The engineering mode has more available overlay options and the granularity with which the data is displayed is finer.

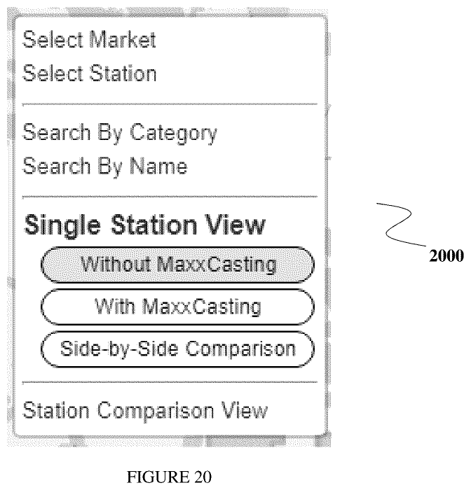

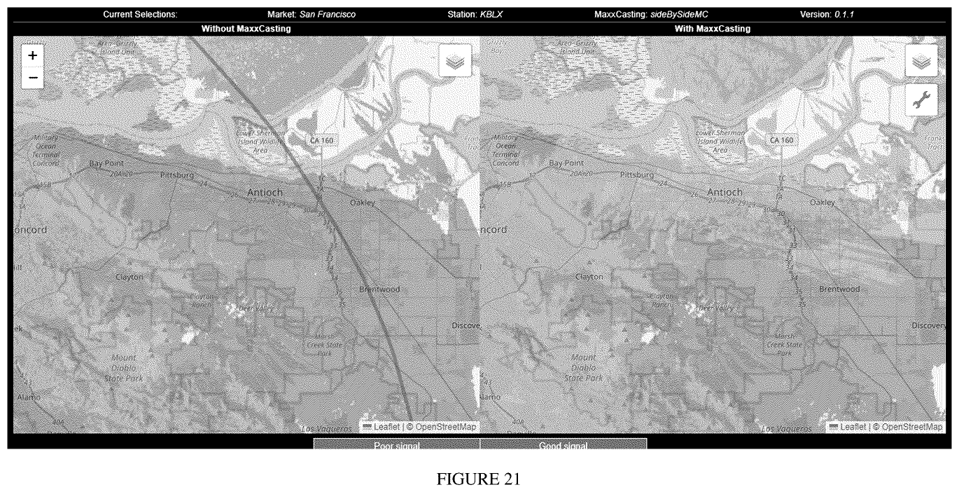

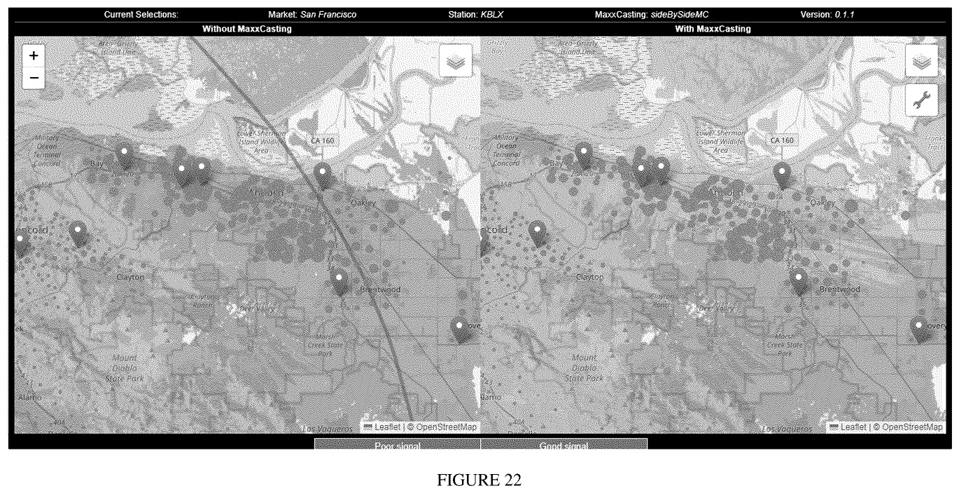

In this regard, FIG. 20 illustrates the field/drop-down menu icon 2000 that enables input and reception of a user's selection of analysis functionality associated with side-by-side-comparison of demonstrated effect of implementation of a coverage optimization technology, e.g., MaxxCasting™ v. Without MaxxCasting™ and documentation of the same (see FIG. 21). Further, POI and other overlays function as they do in the above station comparison workflow; as a result, a user is able to understand, demonstrate and document the effect of implementing a coverage optimization technology on specified POIs within a particular broadcast area as shown in FIG. 22.

With this understanding of the disclosed embodiments in mind, it should be understood that the signal broadcasting related equipment is provided that enables design, deployment, demonstration and/or documentation of targeted transmitted broadcast delivery in a broadcast area wherein a plurality of transmitters are used to transmit broadcasting area wide programming and localized auxiliary information on a single frequency and wherein the plurality of transmitters includes at least on main transmitter for transmitting broadcast area wide programming and, optionally, a plurality of booster transmitters for transmitting localized, targeted auxiliary information so as to provide customized, targeted content for delivery to particular locations and areas.

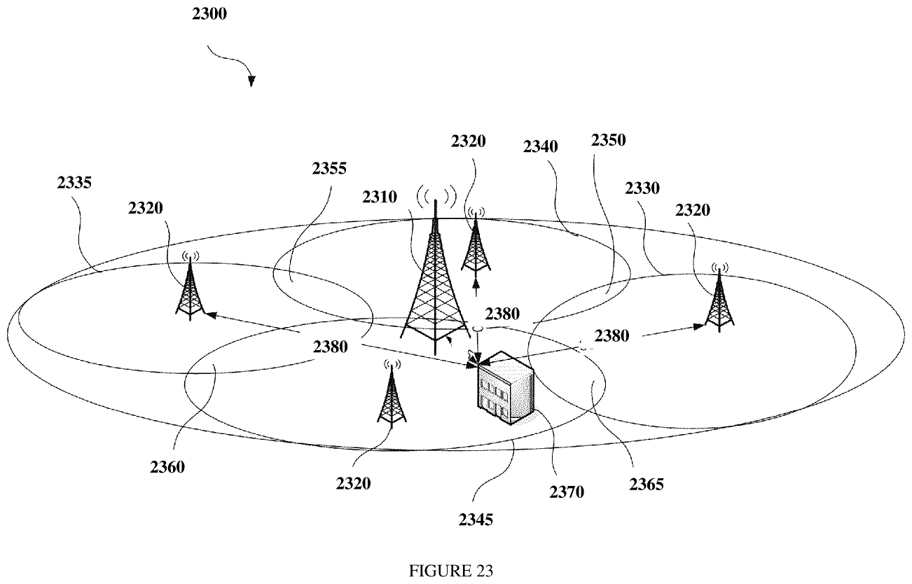

Thus, the presently disclosed embodiments are meant to enable improved utility of the cooperative configuration of the broadcast system components, of which an example is illustrated in FIG. 23. FIG. 23 illustrates a radio broadcast listening area environment in which one or more of the illustrated embodiments may be utilized to deliver broadcast area wide programming as well as localized auxiliary information via a plurality of antennas on a single frequency. It should be understood that some or all of the components illustrated in FIG. 23 may cooperate in a manner that enables the transmitter to communicate with, for example, a studio such as studio 2370 to receive broadcast area wide programming and/or localized area programming for distribution via the transmitter.

To determine whether an antenna configuration associated with a particular transmitter is configured appropriately, one must consider the relative signal strength and total transmission delay experienced by a receiver in the capture area for that transmitter. For example, two neighboring transmitters may have equal transmission power but the total transmission delay between the studio and each transmitter may be different, based on audio processing time and path delay. Thus, when a receiver is located in the capture area associated with one of the transmitters (e.g., capture areas 2330, 2335, 2340, 2345 illustrated in FIG. 23), the amplitude limiting circuitry for the receiver should cause the receiver to lock in the broadcast transmission emanating from that transmitter; this is because the signal from the associated transmitter 2320 should be much stronger in the associated capture area then the broadcast signal from a neighboring transmitter. In such a situation, the signal from the neighboring transmitter can be considered an interfering signal. However, when the receiver is located in the overlap area 2350, 2355, 2360, 2365, the receiver may receive broadcast signals of almost equal strength from multiple transmitter sites. These signals interfere with each other.

Thus, in accordance with at least some disclosed embodiments, the system and methodologies estimate transmission signal quality to provide data indicating a coverage area reached by a broadcast system 2300 as a result of location and broadcast parameters for the at least one main transmitter 2310 and the optional booster transmitter(s) 2320. In this way, the forecast transmission signal quality data may be used to design and deploy the constituent components of the broadcast system (including to control broadcast parameters) to optimize incremental population served in the coverage area by the broadcast system, regardless of whether the broadcast system pertains to terrestrial radio, terrestrial television or satellite broadcasting. Of note, the optimization of the broadcast system parameters may be used to ensure certain signal levels received from the broadcast system are suitable for high quality fixed and mobile reception.

In accordance with at least some disclosed embodiments, geospatial and other data may be included in a database and generated by a model of three-dimensional terrestrial radio, terrestrial television or satellite broadcast signal strength levels in a variety of geospatial and other application data formats. Associated Application Programming Interfaces (APIs) may also be provided for use in applications including radio frequency coverage design applications, SFN design, signal strength coverage optimization, and applications for geo-targeting specific content. For example, such specific content may include program material, public service announcements, advertising, non-program related datacasting services, or other content known to be conventionally broadcast via terrestrial radio, terrestrial television or satellite broadcast systems.

In accordance with at least some disclosed embodiments, the system and methodologies may be used to predict the population of fixed and mobile receiver locations reached by a broadcast system including one or more main transmitters and optionally a plurality of booster transmitters transmitting at specified signal strength levels.

In conjunction with this functionality, the system and methodologies may be configured to predict the population reached and population characteristics (e.g., demographic, economic, or other population data) in the fixed and mobile locations reached by at least one main transmitter and optionally one or more booster transmitters transmitting at specified signal strength levels.

As a result, the system and methodologies may be used to generate forecast data indicating predicted broadcast advertising revenue based on population reached (and related data) by a broadcast system including at least one main transmitter and optionally one or more booster transmitters with specified signal levels.

Still further, the system and methodologies may be used to generate forecast data indicating predicted the broadcast audience estimates differentiated content and services (e.g., geotargeted content and services differentiated from that broadcast from the main transmitter and which originates from on one more of the booster transmitters) based on population reached with transmitted broadcast signals at specified signal levels. Likewise, in accordance with disclosed embodiment, the system and methodologies may be used to generate forecast broadcast advertising revenues based on population reached with transmitted signals having specified signal levels, wherein the transmitted signals originate geo-targeted content and services differentiated from that transmitted from the main transmitter, instead, originating from the one or more booster transmitters.

In accordance with at least some disclosed embodiments, the system and methodologies may be used to design, deploy, demonstrate (e.g., verify) and/or document transmission signal strength levels at various “points of interest. For example, business locations, event locations, and other venues to indicate whether transmission signal levels are receivable and acceptable for certain purposes. Likewise, such transmission signal analysis may be used in system design and deployment and/or for demonstration or documentation for particular areas and also provide signal strength level data enabling comparison of coverage areas of two or more signals.

In this regard, disclosed embodiments of the system and methodologies may be used to capture, store and reproduce samples of terrestrial radio, terrestrial television or satellite broadcast signals to enable the assessment of the broadcast signal quality associated within a given geographic location or in a given geographic region. This may be performed to assess the quality of received signals at certain geographic locations within the broadcast system coverage area, or to assess the perceptual Quality of Experience from signals received for voice, audio and data at certain geographic locations. For this functionality, the system and methodologies may incorporate certain tools, methods, and models such as BRISQUE, POLQA, VISQOL to perform assessment of the Quality of Experience.

As a result of the functionality and system utility described herein, configurations of the disclosed embodiments enable the ability to reach underserved communities through generation of a demonstrably improved broadcast signal. Additionally, disclosed embodiments also can provide zoned, customized, broadcast content to a plurality of dialect and ethnic groups. In this way, broadcast stations can reach individual cultural communities with individualized content but on a single frequency collectively. In particular, disclosed embodiments enable the design and implementation of a network of zones that may be forecast, implemented and demonstrably verified to reach unique dialect, ethnic group or at-risk populations through a single broadcast platform.

As a result, it should be understood that the present technology may be used in metropolitan areas including diverse communities speaking different languages, different dialects or facing distinct content needs. For example, consider the possibility that a particular geographic area within a broadcast market suffers from a lack of food markets providing quality food items (sometimes referred to as a food desert). Such communities may be benefit from receiving targeted information indicating the location of newly located food markets, the potential for receiving food subsidies and/or the availability of government supported programs that facilitate and support local food farming within the geographic community. The availability of such information is only as effective as the ability to transmit the information to the targeted community in need of these support mechanisms. Accordingly, disclosed embodiments enable the ability to determine areas in need of further service, e.g., food markets, water purification, etc., and provide a mechanism for altering radio broadcast (or other media) services to design, deploy demonstrate and/or document dissemination of information to the populations in these areas.

On a more technical level, it should be understood that the presently disclosed embodiments provide a mechanism for analyzing, demonstrating and documenting various operation aspects of the collaborative operation of broadcast area components for a particular station. Such functionality enables effective understanding, demonstration, documentation and remediation of the following issues facing broadcasters: identifying and managing and/or eliminating signal overlap during ZoneCasting™ with an alternate main transmitter and/or one or more booster transmitters, inventorying and managing timing of RF Overlay in a broadcast area including more than one transmitter operating on the same frequency, inventorying and managing ZoneCasting™ of push promotions to smart devices and managing ZoneCasting™ linked to smart devices

While this invention has been described in conjunction with the specific embodiments outlined above, it is evident that many alternatives, modifications and variations will be apparent to those skilled in the art. Accordingly, the various embodiments of the invention, as set forth above, are intended to be illustrative, not limiting. Various changes may be made without departing from the spirit and scope of the invention.

For example, it should be understood that various disclosed embodiments relate to the broadcasting of various types of transmitted signals. Thus, it should be understood that the embodiments are not limited to analog radio broadcasting and may be utilized in digital audio radio broadcasting, for example, Eureka 147 (also known as Digital Audio Broadcasting (DAB)), ′DAB+, FM band in-band on-channel (FM IBOC) broadcasting including HD Radio (OFDM modulation over FM and AM band IBOC sidebands) and FMeXtra (FM band IBOC subcarriers), Digital Radio Mondiale (DRM) and its extension (DRM+) (OFDM modulation over AM band IBOC sidebands), AM band in-band on-channel (AM IBOC) including HD Radio (AM IBOC sideband) and DRM, Satellite radio including, e.g., WorldSpace, Sirius XM radio, and MobaHo!, Integrated Services Digital Broadcasting (ISDB), Low-bandwidth digital data broadcasting over existing FM radio, RDS/RBDS, etc.

It should be further appreciated that, in accordance with at least one embodiment of the invention, the systems and methodologies may be implemented in conjunction with the transmission of signals transmitted in conjunction, and compatible, with the DAB standard to enable implementation outside the United States radio markets.

Further, it should be appreciated that the various disclosed embodiments and their individual aspects and features also may be utilized in the transmission of analog and/or digital television signals, for example ATSC 1.0 and/or ATSC 3.0 television signals.

It should be understood that various connections are set forth between elements in the following description; however, these connections in general, and, unless otherwise specified, may be either direct or indirect, either permanent or transitory, and either dedicated or shared, and that this specification is not intended to be limiting in this respect.

Additionally, it should be understood that the functionality described in connection with various described components of various invention embodiments may be combined or separated from one another in such a way that the architecture of the invention is somewhat different than what is expressly disclosed herein. Moreover, it should be understood that, unless otherwise specified, there is no essential requirement that methodology operations be performed in the illustrated order; therefore, one of ordinary skill in the art would recognize that some operations may be performed in one or more alternative order and/or simultaneously.

Various components of the invention may be provided in alternative combinations operated by, under the control of or on the behalf of various different entities or individuals.

Further, it should be understood that, in accordance with at least one embodiment of the invention, system components may be implemented together or separately and there may be one or more of any or all of the disclosed system components. Further, system components may be either dedicated systems or such functionality may be implemented as virtual systems implemented on general purpose equipment via software implementations.

Unless otherwise expressly stated, it is in no way intended that any operations set forth herein be construed as requiring that its steps be performed in a specific order. Accordingly, where a method claim does not actually recite an order to be followed by its steps or it is not otherwise specifically stated in the claims or descriptions that the operations are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of the specification and practice disclosed herein. It is intended that the specification and examples be considered as exemplary only, with a true scope and spirit being indicated by the following inventive concepts.

Although the utility of various embodiments may have been illustrated and described in connection with the distribution of various types of content, it should be understood that distributed information is not limited to promotional content but may also or alternatively include non-promotional material. For example, content served to localized areas in accordance with the disclosed embodiments may relate to food banks, emergency services, and other support services for communities that may support communities that reside in a geographic area that changes over time. Thus, it should be understood that transmission parameters of a radio station may be analyzed and altered based on the functionality of the disclosed invention to alter a coverage area indicating one or more emergency issues and related services. For example, as the scope of a water contamination issue alters over time, the coverage area to which a focused emergency services notification may be altered through intelligent control of transmission parameters for signal transmission.

As a result, it will be apparent for those skilled in the art that the illustrative embodiments described are only examples and that various modifications can be made within the scope of the invention. The description of specific embodiments is not intended to be limiting of the present invention. To the contrary, those skilled in the art should appreciate that there are numerous variations and equivalents that may be employed without departing from the scope of the present invention. Those equivalents and variations are intended to be encompassed by the present invention.

Such computing devices may comprise a variety of computer readable media. Exemplary readable media can be any available media that is accessible by the computer and comprises, for example and not meant to be limiting, both volatile and non-volatile media, removable and non-removable media. The system memory comprises computer readable media in the form of volatile memory, such as Random Access Memory (RAM), and/or non-volatile memory, such as Read Only Memory (ROM). The system memory typically contains data such as data and/or program modules such as the operating system and software that are immediately accessible to and/or are presently operated on by the processing unit.

In another aspect, the computer can also comprise other removable/non-removable, volatile/non-volatile computer storage media. By way of example, the mass storage device can provide non-volatile storage of computer code, computer readable instructions, data structures, program modules, and other data for the computer. For example and not meant to be limiting, a mass storage device can be a hard disk, a removable magnetic disk, a removable optical disk, magnetic cassettes or other magnetic storage devices, flash memory cards, CD-ROM, Digital Versatile Disks (DVD) or other optical storage, RAM, ROM, Electrically Erasable Programmable Read-Only Memory (EEPROM), and the like.

Optionally, any number of program modules can be stored on the mass storage device, including by way of example, the operating system and software. Each of the operating system and software (or some combination thereof) can comprise elements of the programming and the software. Data can also be stored on the mass storage device in any of one or more databases known in the art. Examples of such databases comprise, DB2™, Microsoft™ Access, Microsoft™ SQL Server, Oracle™, mySQL, PostgreSQL, and the like. The databases can be centralized or distributed across multiple systems.

It should be understood that a user can enter commands and information into the computer via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit(s) via the human machine interface that is coupled to the system bus, but can be connected by other interface and bus structures, such as a parallel port, game port, an IEEE 1394 Port (also known as a Firewire port), a serial port, or a universal serial bus (USB).

Additionally, it should be understood that the display device can also be connected to the system bus via an interface such as the display adapter. It is contemplated that the computer can have more than one display adapter and the computer can have more than one display device.

The computer can operate in a networked environment using logical connections to one or more remote computing devices. By way of example, a remote computing device can be a personal computer, portable computer, a server, a router, a network computer, a peer device or other common network node, and so on. Logical connections between the computer and a remote computing device can be made via a Local Area Network (LAN) and a general Wide Area Network (WAN). Such network connections can be through a network adapter that may be implemented in both wired and wireless environments. Such networking environments are conventional and commonplace in offices, enterprise-wide computer networks, intranets, and the Internet.

For purposes of illustration, application programs and other executable program components such as the operating system are illustrated herein as discrete blocks, although it is recognized that such programs and components reside at various times in different storage components of the computing device, and are executed by the data processor(s) of the computer. An implementation of software can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any method or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

In explaining the operation of various disclosed embodiments, description of one or more “main transmitters” and “booster transmitters” has been provided. It should be understood that the term “main transmitter” encompasses a transmitter that may be, for example, the only transmitter used by a radio broadcaster in a particular radio broadcasting area or it may be the most powerful (or one of the most powerful) transmitters in the radio broadcasting area.

To the contrary, the term “booster transmitter” (which is interchangeable with the term “signal boosters” or “auxiliary transmitters”) includes low-power transmitters (relative to the maximum class of the main transmitter), which are conventionally used to improve communications in locations within the normal coverage area of a radio system where the radio signal is blocked or shielded due to natural terrain or man-made obstacles (e.g., to provide fill-in coverage but not increase the normal coverage area).

Although it is conventionally known that booster transmitters can be effective in weak or no-signal areas that may be present in a radio broadcaster's area of operation, conventional use of booster transmitters has not been widely adopted because it routinely results in additionally interference in the transmitted signal. Thus, although conventional booster transmitters can be used to compensate or accommodate for physical barriers to effective radio broadcast transmission, e.g., mountains, mountain ranges, steep valleys, large buildings, vegetation, etc., are not often used because they create interference with the main transmitter signal which results in an increase problem rather than a solution.

1. Signal broadcasting related equipment for at least one of design, deployment, demonstration and documentation of targeted transmitted broadcast delivery in a broadcast area, the equipment comprising:
at least one network analyzer;
a plurality of receivers coupled to the at least one network analyzer; and
at least one computer processor coupled to and controlling the plurality of receivers and the at least one network analyzer to receive and analyze signal transmissions transmitted from a plurality of transmitters at a single frequency within the broadcast area to determine signal strength data for the single frequency signal transmission throughout the broadcast area.

2. The equipment of claim 1, wherein the single frequency is a radio frequency associated with a radio station transmitting within the broadcast area.

3. The equipment of claim 1, wherein the equipment further comprises at least one server that analyzes the determined signal strength data and generates a graphical depiction of relative signal strength in the broadcast area for review by a user.

4. The equipment of claim 3, wherein the at least one server is further configured to output data indicating areas of interference between the plurality of transmitters.

5. The equipment of claim 1, wherein the plurality of transmitters include at least one main transmitter and a plurality of booster transmitters operating on the same single transmission frequency to broadcast data to fixed and mobile user receivers included in the broadcast area.

6. The equipment of claim 5, wherein the at least one server is further configured to output data indicating areas of interference between the main transmitter and the plurality of booster transmitters and/or between multiple booster transmitters of the plurality of booster transmitters.

7. The equipment of claim 5, wherein the plurality of booster transmitters transmits content different from that of the at least one main transmitter at various times to deliver differentiated broadcast content to a localized section of the broadcast area.

8. The equipment of claim 3, wherein the graphical depiction of relative signal strength in the broadcast area includes a three-dimensional geospatial map including latitude, longitude and altitude data, which is stored in one or more databases or data stores in computer memory and analyzed to forecast terrestrial radio, terrestrial television or satellite broadcast signal strength level estimates for reception by fixed and mobile receivers.

9. The equipment of claim 3, wherein the at least one server is further configured to overlay demographic data on the graphical depiction of the broadcast area, the overlay demographic data indicating characteristics of human population in the broadcast area with associated signal strength data.

10. The equipment of claim 3, wherein the at least one server is further configured to overlay data indicating commercial and non-commercial products and/or services on the graphical depiction of the broadcast area, the overlay data being organized and available for overlay based on categories of available products and/or services for the locations.

11. A method for use in at least one of design, deployment, demonstration and documentation of targeted transmitted broadcast delivery in a broadcast area, the method comprising:
transporting at least one mobile field unit within a broadcast area, the at least one field unit including at least one network analyzer, a plurality of receivers coupled to the at least one network analyzer, and at least one computer processor coupled to and controlling the plurality of receivers and the at least one network analyzer;
controlling the plurality of receivers and the at least one network analyzer to receive and analyze signal transmissions transmitted from a plurality of transmitters at a single frequency within the broadcast area to determine signal strength data for the single frequency signal transmission throughout the broadcast area;
transmitting the determined signal strength data to at least one server; and
analyzing the transmitted signal strength data by the at least one server to generate a graphical depiction of relative signal strength in the broadcast area for review by a user.

12. The method of claim 11, wherein the single frequency is a radio frequency associated with a radio station transmitting within the broadcast area.

13. The method of claim 10, further comprising generating and outputting, by the at least one server, output data indicating areas of interference between the plurality of transmitters.

14. The method of claim 10, further comprising, analyzing, by the at least one server, the determined signal strength data and generating a graphical depiction of relative signal strength in the broadcast area for review by a user.

15. The method of claim 13, further comprising outputting, by the at least one server, output data indicating areas of interference between the plurality of transmitters.

16. The method of claim 10, wherein the plurality of transmitters include at least one main transmitter and a plurality of booster transmitters operating on the same single transmission frequency to broadcast data to fixed and mobile user receivers included in the broadcast area.

17. The method of claim 16, wherein the at least one server is further configured to output data indicating areas of interference between the main transmitter and the plurality of booster transmitters and/or between multiple booster transmitters of the plurality of booster transmitters.

18. The method of claim 16, wherein the plurality of booster transmitters transmits content different from that of the at least one main transmitter at various times to deliver differentiated broadcast content to a localized section of the broadcast area.

19. The method of claim 14, wherein the graphical depiction of relative signal strength in the broadcast area includes a three-dimensional geospatial map including latitude, longitude and altitude data, which is stored in one or more databases in computer memory and analyzed to forecast terrestrial radio, terrestrial television or satellite broadcast signal strength level estimates for reception by fixed and mobile receivers.

20. The method of claim 14, wherein the at least one server is further configured to overlay demographic data on the graphical depiction of the broadcast area, the overlay demographic data indicating characteristics of human population in the broadcast area with associated signal strength data.

21. The method of claim 14, wherein the at least one server is further configured to overlay data indicating commercial and non-commercial products and/or services on the graphical depiction of the broadcast area, the overlay data being organized and available for overlay based on categories of available products and/or services for the locations.

22. A non-transitory computer readable medium including a computer program with instructions, which when implemented on a computer processor, control the processor to perform the method of claim 11.
